(19) United States
(12) Patent Application Publication
(10) Pub. No.: US 2026/0326429 A1
(43) Pub. Date: Oct. 22, 2026

(54) COATING PROCESS OF A PREFORMED SUBSTRATE

(71) Applicant: PERSICO S.P.A., NEMBRO (IT)

(72) Inventors: Andrea FUMAGALLI, NEMBRO (IT); Matteo RADI, NEMBRO (IT)

(21) Appl. No.: 18/994,880

(22) PCT Filed: Jul. 14, 2023
(86) PCT No.: PCT/IT2023/050164

§ 371 Date: Jan. 15, 2025

(30) Foreign Application Priority Data
Jul. 20, 2022 (IT) 102022000015291

(51) Int. Cl. B32B 37/12; B29C 35/08; B29C 43/20; B29C 43/52; B32B 7/12; B32B 37/06

(52) U.S. Cl. CPC B32B 37/1207; B29C 35/0805; B29C 43/203; B29C 43/52; B32B 7/12; B32B 37/06; B29C 2035/0822; B32B 2037/1215; B32B 2037/1253

(57) ABSTRACT

Process for coating a preformed substrate (10), wherein the process comprises:—providing a semi-finished product (99) comprising the preformed substrate (10), a coating layer (6) superimposed to the preformed substrate (10), and a layer of adhesive (7) interposed between the preformed substrate (10) and the coating layer (6);—heating the semi-finished product (99) by of infrared irradiation for bringing the layer of adhesive (7 ) to a temperature greater than or equal to an activation temperature of the adhesive (7);—subsequently, compressing said semi-finished product (99) by pressing said preformed substrate (10) and said coating layer (6) against each other, While cooling said coating layer (6).

### TECHNICAL FIELD OF THE INVENTION

The present invention relates to a process for coating a preformed substrate, for example to make a composite product for the interior finishes of vehicles (e.g., trim panels for doors, for planks, for pillars, for dashboards, for roof linings, etc.), of boats, of aircrafts, and/or furniture components.

### STATE OF THE ART

For the production of composite products, such as for the aforementioned interior finishes, it is known covering a preformed, namely already formed before the process for coating, substrate (typically made of rigid plastic material), with (at least) a coating layer. This coating layer provides the desired tactile and/or aesthetic properties to the finished product and typically comprises at least one aesthetic sheet that remains visible during the use of the finished composite product and that, for example, can be made of: natural textile fabric, synthetic textile fabric, natural leather, artificial leather (i.e. a material having mechanical and/or tactile and/or aesthetic properties that recall the natural leather), etc. The coating layer may also comprise a functional layer, for example, a layer made of polymeric foam (for example polyurethane), which, in the finished product, is interposed between the substrate and the aesthetic sheet for giving specific properties to the finished product (e.g., tactile properties of hard-touch/soft-touch).

### SUMMARY OF THE INVENTION

In the above context, the Applicant has faced the problem of coating a preformed substrate by an industrial process that is simple (e.g., in terms of equipment used and/or operations required), fast, and/or cheap (e.g., in terms of energy efficiency and/or initial investment and/or space requirements), and that allows at the same time to obtain a robust and/or durable adhesion between the substrate and the coating layer and/or the desired aesthetic properties of the finished composite product (in particular of the visible face of the coating layer).

According to the Applicant the above problem is solved by a process for coating a preformed substrate according to the attached claims and/or having one or more of the following features. According to an aspect the invention relates to a process for coating a preformed substrate. Preferably the process comprises:
providing a semi-finished product comprising:
   i) said preformed substrate,
   ii) a coating layer superimposed to said preformed substrate, and
   iii) a layer of adhesive interposed (in contact) between said preformed substrate and said coating layer;
heating said semi-finished product by infrared irradiation for bringing said layer of adhesive to a temperature greater than or equal to an activation temperature of said adhesive;
subsequently, compressing said semi-finished product by pressing said preformed substrate and said coating layer against each other, while cooling (at least) said coating layer.

In the context of the above process for coating a preformed substrate (i.e. already having the shape desired with the finished product), the Applicant considers particularly advantageous heating the semi-finished product by infrared irradiation (e.g., by means of a radiation having a substantial part—e.g., at least 70% or 80%—of the emission power falling within the spectral band between 0.7 μm—preferably 1 μm, and 8 μm—preferably 5 μm, more preferably 3 μm, extremals included), for bringing the adhesive layer to a temperature greater than or equal to the activation temperature of the adhesive. At this temperature the adhesive assumes properties such that to wet the surfaces to be glued and to realize the adhesion between the components (typically the adhesive retains these properties even in a temperature range above the activation temperature).

The heating by infrared radiation gives the process for coating of the present invention energy efficiency and/or speed of execution, thanks for example to the ability of the infrared radiation to penetrate the coating layer. Furthermore, heating by infrared radiation avoids the direct contact between the semi-finished product and the heat source, significantly reducing the risk of damage of the coating layer (e.g., onset of aesthetic defects such as opacity, gloss, burns, loss of color, etc.), particularly in case of coatings of natural leather and/or artificial leather (e.g., TPO, PVC, Alcantara™, etc.).

For example, in a comparative case of heating of the semi-finished product performed by thermal conduction from a hot body (e.g., an half-mould) arranged in direct contact with the coating layer (particularly with the aesthetic side of the coating layer), the heating would take long times for bringing the adhesive layer to the desired temperature, and/or high energy consumption, for example for bringing and keeping the hot body, typically having considerable mass, to the desired temperature, and/or could result (due to the direct contact between the hot body and the coating layer) in the onset of aesthetic defects at the aesthetic side of the coating layer, resulting in rejection of the finished piece.

The combination of the compression of the semi-finished product (which places the substrate in intimate contact with the coating layer) and the simultaneous cooling of the coating layer (which in turn cools the layer of adhesive, which for example hardens) makes a solid and durable adhesion between the two elements.

The Applicant has therefore realized that the infrared heating up (at least) to the activation temperature of the adhesive renders superfluous further heating phases of the semi-finished product (such as a further heating phase of the semi-finished product by thermal conduction by a hot body in contact with the coating layer), allowing to save in terms of space and/or of investment/maintenance costs, and/or to reduce the above problems of aesthetic defects. In other words, the Applicant has surprisingly discovered that it is possible to subject the semi-finished product heated after the single infrared heating phase directly to the compression and cooling phase, without the need for further intermediate heating phases.

The present invention in one or more of the above aspects may present one or more of the following preferred features.

Preferably heating said semi-finished product by infrared irradiation is performed with said semi-finished product laid on a support surface of a support element.

Preferably heating said semi-finished product by infrared radiation is performed by means of an infrared source, preferably faced to said support surface.

Typically, it is provided arranging said semi-finished product in a mould comprising a first and a second half-mould each having a respective compression surface. Preferably said respective compression surface of said first and/or second half-mould is (substantially) counter-shaped to said preformed substrate. Preferably said compressing said semi-finished product is performed by pressing said first and second half-mould against each other, with said semi-finished product interposed between said compression surfaces (and with said coating layer proximal to said first half-mould). The compression surfaces of the two half-moulds substantially counter-shaped to the shape of the substrate allow not to modify and/or damage the shape of the substrate (which is already preformed) during compression. In this way, at the end of the process for coating, the preformed substrate retains the shape that it originally had and the coating layer takes the form of the substrate.

Typically, said second half-mould is located below said first half-mould. Typically, said infrared source is located above said support element.

Preferably said cooling is performed maintaining a temperature of said first half-mould less than said activation temperature of said adhesive.

In a preferred embodiment said support element coincides with said second half-mould (and said support surface coincides with said compression surface of the second half-mould). Preferably providing said semi-finished product comprises placing said semi-finished product on the compression surface of the second half-mould in position separated from the first half-mould (with the substrate proximal to, and typically in contact with, the compression surface of the second half-mould). In this way it is saved further time and space since the second half-mould is also used as support element for the semi-finished product during heating (by coupling the second half-mould to the first half-mould only after heating). Preferably it is provided moving the semi-finished product by translation (e.g., sliding on rails) of the second half-mould from a first position, in which it faces the infrared source, to a second position, in which it is located at the first half-mould (and aligned to the latter to then allow the closing of the mould), and vice versa.

In one alternative embodiment, said support element is distinct and separated from said second half-mould. Preferably it is provided moving (e.g., manually by an operator or automatically by appropriate means of moving, such as a robot arm) the semi-finished product from the support element to the second half-mould. In this way it is advantageously possible to differentiate the operating temperatures of the support element and the second half-mould. Preferably said support surface is (substantially) counter-shaped to said preformed substrate (preferably to a first face of said preformed substrate facing said support element). In this way the semi-finished product can be arranged always with a desired spatial relationship on the support element, in order to ensure a desired alignment with the infrared source (e.g., to improve the heating efficiency, as described below).

Preferably, (at least) during said heating the semi-finished product by irradiation, it is provided keeping said support element at a temperature greater than or equal to 35 °C, more preferably greater than or equal to 40 °C. In this way it is possible to contribute to the heating of the layer of adhesive also by thermal conduction from the support element.

Preferably, (at least) during said heating the semi-finished product by irradiation, it is provided keeping said support element at a temperature less than or equal to 65 °C, more preferably less than or equal to 60 °C. In this way it is possible to reduce the risks (e.g., burn) for the operators and/or to not counteract the cooling in the subsequent compression phase.

Preferably heating said semi-finished product by infrared irradiation is performed by directly (and only) irradiating said coating layer, more preferably a free face of said coating layer (facing the source and distal from said layer of adhesive). In this way a high efficiency and/or fast heating is obtained.

Preferably said heating said semi-finished product by infrared irradiation comprises maintaining, along a reference direction, a first distance between each irradiating point (of said infrared source) and said free face of the coating layer within a first (symmetrical) neighborhood of a first reference value. Preferably said first neighborhood has extremes respectively equals to +/−15% (more preferably +/−10%) of said first reference value. In other words, the irradiation surface (that is, the three-dimensional surface, possibly discontinuous, defined by the set of all radiating points of the infrared source) follows (substantially) the three-dimensional development of the face of the coating facing towards the source, in order to heat in a spatially uniform way the adhesive (e.g., even in case of non-flat substrate). The Applicant has in fact found that a spatially uniform temperature of the adhesive (for example having a variability in a neighborhood equal to +/−10% with respect to an average value of temperature of the adhesive) is very advantageous in terms of quality of the bonding and uniformity of the adhesion. It is observed that the aforementioned free face of the coating layer (as well as the second face of the substrate proximal to it) typically has a three-dimensional development in space, that is not flat.

Preferably said infrared source comprises a main body having a fixing surface facing said substrate (substantially) counter-shaped to said second face of the substrate (or to said free face of the coating layer).

Preferably a second distance, along a reference direction, between each point of said fixing surface and said free face of the coating layer is comprised in a second (symmetrical) neighborhood of a second reference value. Preferably said second neighborhood has extremes respectively equal to +/−15% (more preferably +/−10%, still more preferably +/−5%) of said second reference value. In this way it is possible to implement the above irradiation surface with three-dimensional development.

Preferably said infrared source comprises a plurality of sub-sources fixed to said main body at said fixing surface. In this way the irradiation surface as described above is easily obtained.

Preferably said plurality of sub-sources is spatially homogeneously distributed on said fixing surface of the main body. In this way it is promoted the uniformity of heating.

In one embodiment each sub-source is a filament infrared lamp, preferably with single or double filament.

Preferably a pitch between two adjacent filament infrared lamps is greater than or equal to 70 mm, more preferably greater than or equal to 80 mm, even more preferably greater than or equal to 90 mm, and/or less than or equal to 140 mm, more preferably less than or equal to 130 mm, even more preferably less than or equal to 120 mm.

Preferably said (first or second) reference value is calculated as a linear function of a predetermined coefficient and of said pitch, more preferably as a product between said predetermined coefficient and said pitch. Preferably said predetermined coefficient is greater than or equal to 1.2, preferably greater than or equal to 1.4, and/or less than or equal to 2, more preferably less than or equal to 1.8.

In this way it is improved the efficiency and the uniformity of the heating, for example in terms of irradiation uniformity.

In one embodiment said infrared source is a lamellar lamp.

Preferably each sub-source is a metal strip (or thin band) suitable for emitting an infrared radiation when brought to a determined temperature, e.g., when subjected to an electric voltage (in other words, when heated, for example by the Joule effect, it emits an infrared radiation).

Preferably said strip is (e.g., plastically) deformable. In this way, the strip can be adapted to the three-dimensional shape of the fixing surface, realizing the aforementioned three-dimensional irradiation surface.

Preferably each strip is made of Ni—Cr alloy (i.e., Nickel-Chromium alloy), more preferably having a Nickel content by weight greater than or equal to 60% and less than or equal to 90% and/or a Chromium content by weight greater than or equal to 10% and less than or equal to 30%.

Preferably each strip is in single piece.

Preferably one or more strips (e.g., all the strips) are electrically connected in series (for facilitating the electrical tensioning).

Preferably each strip has wavy development along a main development line. In this way the thermal expansion of the strips is compensated by limiting the thermal stresses arising, and/or the irradiation surface is increased. The wavy development can facilitate the adaptation of the strip to the uneven development of the fixing surface.

Preferably each strip has a width (e.g., perpendicularly to a line of main development of the strip) greater than or equal to 2 mm, more preferably greater than or equal to 3 mm, and/or less than or equal to 40 mm, more preferably less than or equal to 30 mm. Preferably each strip has a thickness greater than or equal to 0.01 mm and/or less than or equal to 3 mm, more preferably less than or equal to 2 mm. In this way it contributes to limit the thermal inertia of the strips by promoting their rapid heating.

Preferably said main body is made of a thermally and/or electrically insulating material. In this way it is possible to allow a safe operation of the infrared source, for example, short circuits (e.g., for the passage of current between the two ends of the bands) and/or overheating of the infrared source are avoided.

Preferably said main body of the infrared source comprises a layer of electrically (and/or thermally) insulating material (in contact with said strips) defining said fixing surface.

Preferably (in case of lamellar lamp) said (first or second) reference value is greater than or equal to 15 mm, more preferably greater than or equal to 20 mm, even more preferably greater than or equal to 30 mm, and/or less than or equal to 150 mm, more preferably less than or equal to 120 mm, even more preferably less than or equal to 100 mm.

Preferably said heating said semi-finished product by infrared irradiation is performed for a time interval greater than or equal to 5 s, more preferably 10 s, and/or less than or equal to 60 s, more preferably 50 s.

The above values of (first or second) distance and time allow to obtain the heating of the semi-finished product with the desired uniformity and/or efficiency, by limiting, or avoiding, at the same time an excessive consumption of time and/or energy, and/or an overheating of the coating layer (particularly at the free face facing the infrared source) that could lead to aesthetic defects.

Preferably said temperature of the first half-mould is less than or equal to 30 °C, more preferably less than or equal to 25 °C, even more preferably less than or equal to 20 °C, and/or greater than or equal to 10 °C, more preferably greater than or equal to 15 °C. In this way it is possible to speed up the cooling phase of the semi-finished product and therefore of the adhesive, further reducing the overall time of the process.

Preferably, during said compressing, a pressure exerted (by the first and second half-moulds) on said semi-finished product is less than or equal to 1.5 bar, more preferably less than or equal to 1.2 bar, even more preferably less than or equal to 1 bar, and/or greater than or equal to 0.2 bars. These pressures result particularly advantageous to the process (e.g., they do not damage the shape of the preformed substrate and/or the coating layer), without at the same time providing machinery and/or compression systems complex and/or expensive (e.g., structured for supporting high pressures).

Preferably a time interval between an end instant of said heating and a start instant of said compressing is less than or equal to 60 seconds, more preferably less than or equal to 30 seconds, even more preferably less than or equal to 20 seconds. In this way it is limited the cooling of the adhesive.

Preferably said activation temperature of the adhesive is greater than or equal to 45 °C, more preferably greater than or equal to 50 °C, even more preferably greater than or equal to 55 °C, and/or less than or equal to 95 °C, more preferably less than or equal to 90 °C, even more preferably less than or equal to 85 °C. In this way the activation of the adhesive does not lead to excessive heating of the coating layer, which may be damaged (particularly if the coating layer comprises natural and/or artificial leather).

Preferably said temperature of the layer of adhesive (at the end of said heating by infrared irradiation) exceeds said activation temperature of the adhesive by a value less than or equal to 25 °C, more preferably less than or equal to 20 °C, even more preferably less than or equal to 15 °C. In this way it is possible to activate the layer of adhesive effectively and for a sufficiently long time upon completion of the process for coating, without overheating the coating layer (which could bring the above problems of aesthetic defects).

Preferably said adhesive is of reactive type. These adhesives result particularly advantageous to the present process for coating as they typically show relatively low activation temperatures. Preferably said adhesive is a hot-melt adhesive (i.e. solvent-free, also called “hot melt”). The solvent, potentially useful when applying the adhesive, can however penalize the adhesion. In one embodiment said adhesive comprises a water-based solvent. In this way it is avoided the use of chemical (potentially toxic) solvents.

Preferably said adhesive comprises a first component chosen from: acrylic resin, polyurethane resin, epoxy resin, silicone resin, neoprene resin (e.g., polychloroprene), polyolefin resin, polyamide resin. In this way, the adhesive is characterised by activation temperatures which are advantageous for the present process for coating.

Preferably said first component is a polyurethane resin. This first component has been selected by the Applicant as being particularly advantageous to the present process for coating, for example in terms of respective activation temperature, which stands at relatively low values (typically around 60-80 °C), useful in order not to excessively overheat the coating layer.

Preferably providing said semi-finished product comprises spraying and/or spreading said adhesive on at least one, or both, said substrate and coating layer.

Preferably said layer of adhesive has a weight per unit area (“grammage”) greater than or equal to 20 g/m², more preferably greater than or equal to 40 g/m², even more preferably greater than or equal to 60 g/m², and/or less than or equal to 160 g/m², more preferably less than or equal to 140 g/m², even more preferably less than or equal to 120 g/m² . In this way it is possible providing the appropriate adhesive properties, by limiting at the same time the quantities of used material.

Preferably said preformed substrate comprises (more preferably it is made of) a polymeric material, more preferably rigid. Preferably said polymeric material of the substrate is chosen in the group: polyurethane (PU), polyvinyl chloride (PVC), polystyrene, natural fiber, polyethylene terephthalate (PET), polypropylene (PP), or combinations thereof.

Preferably said coating layer comprises (or consists of) an aesthetic sheet which realizes said free face of the coating layer. In this way the desired aesthetic qualities are given.

Preferably said aesthetic sheet is made of one or more among: natural leather, artificial leather (among them for example Alcantara™, Ultrasuede™, Feel Tek™), polyurethane (PU), polyvinyl chloride (PVC), thermoplastic olefins (TPO), fabric (non-woven, woven, knitted, needle-punched) made of synthetic textile fibres (e.g., polyester, aramids, etc.) and/or of natural textile fibres (e.g., cotton, wool, etc.).

In one embodiment said aesthetic sheet is in single piece.

In one embodiment said aesthetic sheet comprises a plurality of pieces (of the same material or of different materials) sewn together. This is the typical case of aesthetic sheets made of some types of materials, such as natural leather or artificial leather, which, even before the process for coating, can be provided with a three-dimensional shape that approaches the shape of the substrate, in particular the second face of the substrate.

Preferably (for example when the aesthetic sheet is in single piece), before said heating by infrared irradiation, it is provided fixing a position of said coating layer on said preformed substrate by fixing means. For example, said fixing means may be mechanical means. Alternatively said fixing said position is performed by localized pre-activation (e.g., performed manually) of some portions of adhesive. In this way it is possible to limit, or avoid, possible displacements/misalignments of the coating layer with respect to the substrate during the process for coating (in particular during the infrared heating) and/or ensure that the coating layer substantially reproduces the shape of the substrate, improving the process yield. In addition, the fact that the coating layer substantially reproduces the shape of the substrate, helps to maintain under control the distance between each irradiation point of the infrared source and the coating layer (e.g., for limiting areas where the coating layer is too close to the source, resulting in the generation of localized hot spots and, therefore, possible aesthetic defects).

Preferably said coating layer comprises a functional layer coupled (in contact) with said aesthetic sheet. Preferably said functional layer is interposed between said layer of adhesive and said aesthetic sheet (i.e. the stratification of the semi-finished product provides for the sequence: substrate, layer of adhesive, possible functional layer, and aesthetic sheet).

Preferably said functional layer is a layer of foam, more preferably polymeric, even more preferably polyurethane, polypropylene and/or polyethylene foam. In this way it is possible to obtain a composite product soft to the touch. The Applicant has in fact realized that heating only by infrared irradiation works efficiently even in the presence of a layer of foam, which can act as thermal insulation.

In one embodiment said layer of foam is made of an open cell foam. The Applicant has observed that the open cell foam (in addition to providing an enhanced softness to the finished product) promotes the penetration of the adhesive into the cells of the foam layer, further promoting the firm and/or durable adhesion between the substrate and the coating layer.

In one embodiment said layer of foam is made of a closed cell foam. In this way the collapse of the layer of foam during the compression is limited, which could cause the formation of aesthetic defects on the aesthetic sheet in the finished product.

### BRIEF DESCRIPTION OF THE DRAWINGS

FIG. 1 partially and schematically shows a plant for the process for coating according to the present invention;

FIGS. 2-4 partially and schematically show some phases of the process for coating according to the present invention performed by means of the plant of FIG. 1;

FIG. 5 schematically shows a further embodiment of the infrared source.

### DETAILED DESCRIPTION OF SOME EMBODIMENTS OF THE INVENTION

The features and the advantages of the present invention will be further clarified by the following detailed description of some embodiment of the present invention, presented by way of example and not limited, with reference to the attached figures.

In the figures, with the reference number 100, it is indicated a plant suitable for performing a process for coating a preformed substrate 10 according to the present invention.

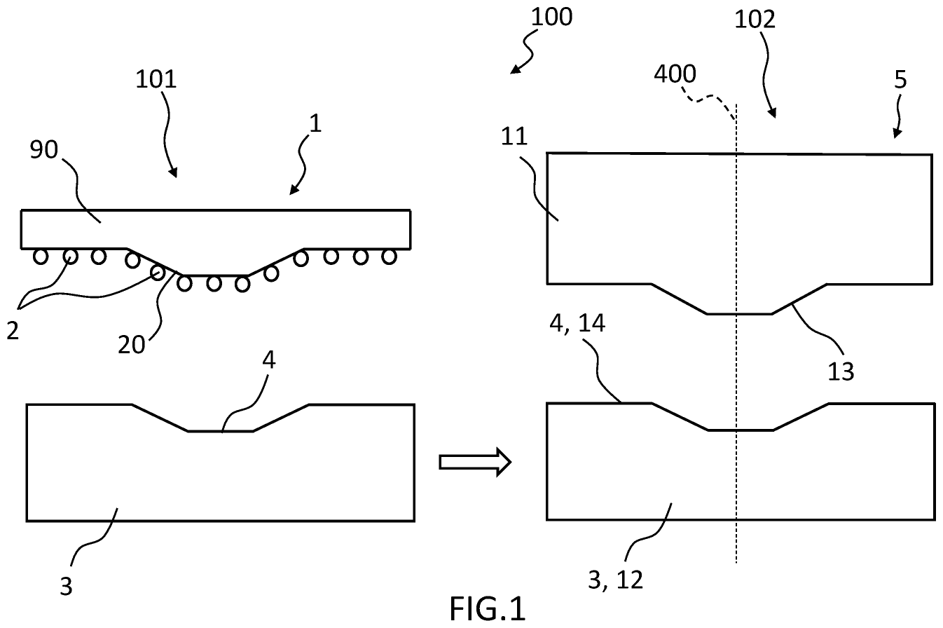

The plant 100 exemplarily comprises a first station 101 for heating and a second station 102 for compressing and cooling. Preferably the second station 102 is arranged immediately downstream of the first station 101 (FIG. 1).

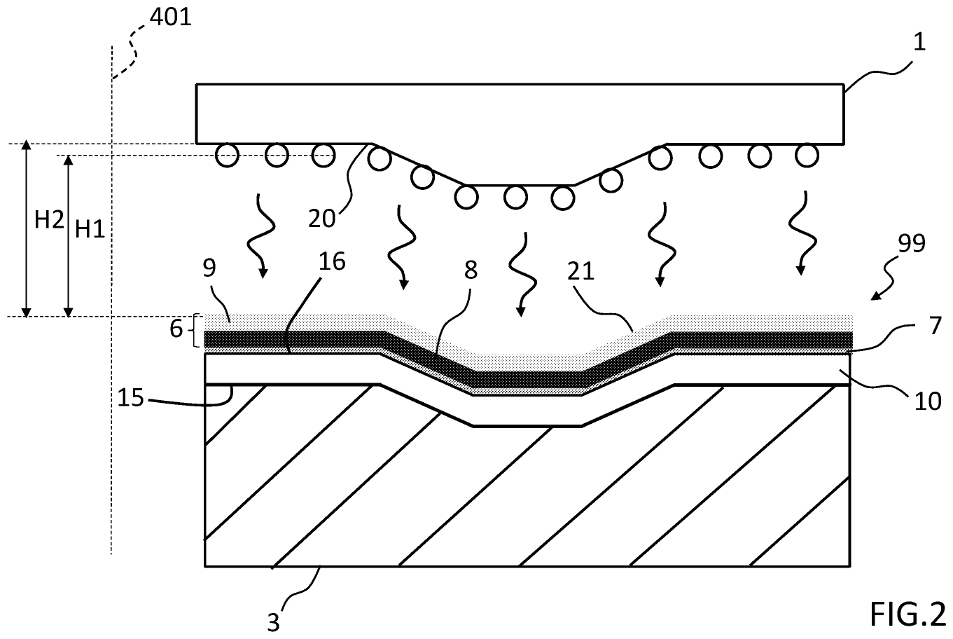

The first station 101 exemplarily comprises a support element 3 which defines a support surface 4 for the substrate 10. Exemplarily the support surface 4 is substantially counter-shaped to a first face 15 of the preformed substrate 10 facing the support element 3 (FIG. 2). Exemplarily the first station 101 also comprises a first thermo-conditioning device (not shown) connected to the support element 3. This first thermo-conditioning device is structured for thermosetting the support element 3 at a desired temperature, and it exemplarily comprises a series of pipes that run through the support element 3 inside of which a heat transfer fluid (e.g., diathermic oil, air or water) flows. Alternatively, the first thermo-conditioning device may comprise a series of electrical resistances within which an electric current pass.

The first station 101 comprises an infrared source 1.

Preferably the infrared source 1 comprises a main body 90 defining a fixing surface 20 facing towards the substrate 10 and a plurality of infrared sub-sources 2 fixed to the fixing surface 20, and distributed in spatially homogeneously onto the fixing surface.

Preferably the conformation of the fixing surface 20 is not flat, but it has a three-dimensional shape so that, in the process for coating, the irradiation surface follows the, typically non-flat, shape of the free face 21 (facing the infrared source) of the coating layer to be irradiated.

Typically, each sub-source 2 has infrared emission band, which can encompass one or more between the near infrared (NIR), with wavelengths for example between 0.75 μm and 1.4 μm, short wave infrared (SWIR), with wavelengths for example between 1.4 μm and 3 μm, and the medium wave infrared (MWIR), for example with wavelengths between 3 μm and 8 μm.

Exemplarily (e.g., as shown in FIGS. 1 and 2) each sub-source 2 is a tubular infrared lamp with double filament, the sub-sources 2 being placed side by side (e.g., with a regular pitch equal to 100 mm) along at least one reference direction to realize an overall irradiation surface of the infrared source 1. For example, the lamps can be arranged side by side in a direction substantially perpendicular to the main development direction of the lamp.

For example, the specific linear power of each double (or single) filament lamp may be about 5 W/mm (with typical power values ranging between 3 W/mm and 7.5 W/mm).

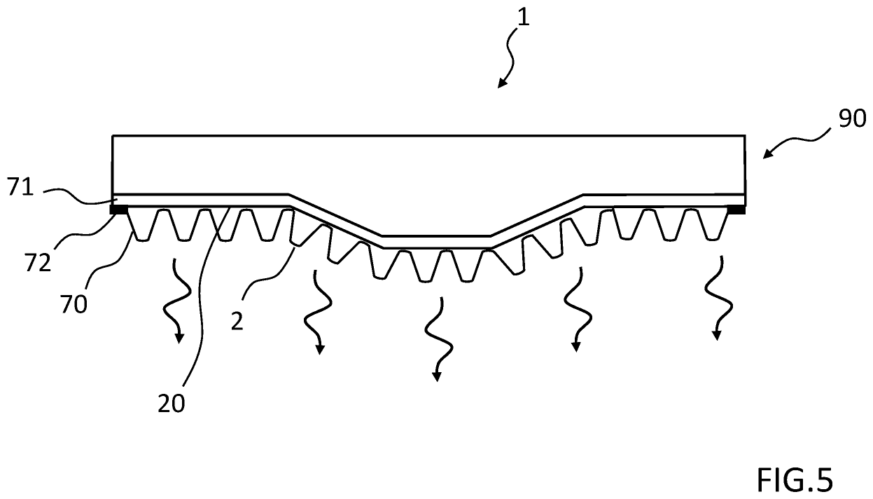

In one alternative embodiment, as schematically shown in FIG. 5 (wherein only one strip 70 is shown in side view), each sub-source 2 is a metal strip 70 (i.e. a thin band), exemplarily in single piece. The strips 70 are deformable so that they can adapt, during the fixing phase, to the three-dimensional conformation (typically not flat) of the fixing surface 20. The strips 70 are typically homogeneously distributed over the fixing surface. In this embodiment, the main body 90 is made of electrically and thermally insulating material. The body 90 can also comprise a layer 71 made of electrically insulating material, such as glass wool or rock wool, in contact with the strips 70, such insulating layer 71 defining the fixing surface 20.

Exemplarily the strips 70 are all electrically connected in series. Exemplarily, a voltage difference (equal for example to 230 V) is applied to the strips at contacts 72 (shown in a purely schematic way).

Exemplarily the strips 70 are made of Ni—Cr 80/20 alloy.

Exemplarily each strip 70 has a wavy pattern, i.e. a main development line with a serpentine pattern (as schematically shown in FIG. 5).

Exemplarily each band 70 has a width equal to about 15 mm and a thickness equal to about 0.7 mm. For example, the specific linear power of each band related to the main development line (e.g., assuming the band as a mono-dimensional element, i.e., neglecting the width of the band) can range from 1 to 40 W/mm of main development (for example these linear power values are calculated by applying the above voltage difference).

Exemplarily the second station 102 comprises a mould 5 comprising a first 11 and a second half-mould 12 each having a respective compression surface 13 and 14. Exemplarily each compression surface 13 and 14 is substantially counter-shaped to the preformed substrate 10, preferably each compression surface is counter-shaped to a respective one among the first 15 and the second face 16 of the substrate 10).

Exemplarily the second half-mould 12 coincides with the support element 3, and therefore the compression surface 14 of the second half-mould 12 coincides with the support surface 4. Exemplarily the plant 100 comprises a handling system (not shown) for handling the support element 3 (for example a track system) that allows the translation (or sliding) of the support element 3 between a first position (shown on the left of FIG. 1), in which it is located facing the infrared source 1, and a second position (shown on the right of FIG. 1), in which it is located at the first half mould 11 (and to the latter vertically aligned to allow the subsequent closure of the mould 5).

Alternatively, the support element 3 can be distinct and separated from the second half-mould 12. In this way it is advantageously possible to use a support surface not counter-shaped to the first face of the substrate. In this embodiment, the plant can for example comprise a robot arm (not shown) for moving the semi-finished product from the first to the second station.

Exemplarily the second station 102 also comprises an opening and closing system (not shown) for opening/closing the mould 5, the opening and closing system being structured for allowing the reciprocal approach and separation of the two half-moulds and the compression of the semi-finished product. For example, the upper half-mould is movable along a vertical direction 400, with the lower half-mould fixed with respect to the vertical direction 400.

Exemplarily the second station 102 also comprises a second thermo-conditioning device (not shown) connected to the first half-mould 11. For example, this second thermo-conditioning device is structured for thermosetting the first half-mould 11 to a desired temperature, and for example it comprises a series of tubes that pass through the first half-mould 11 inside which a heat transfer fluid (e.g., air or water, etc.) flows.

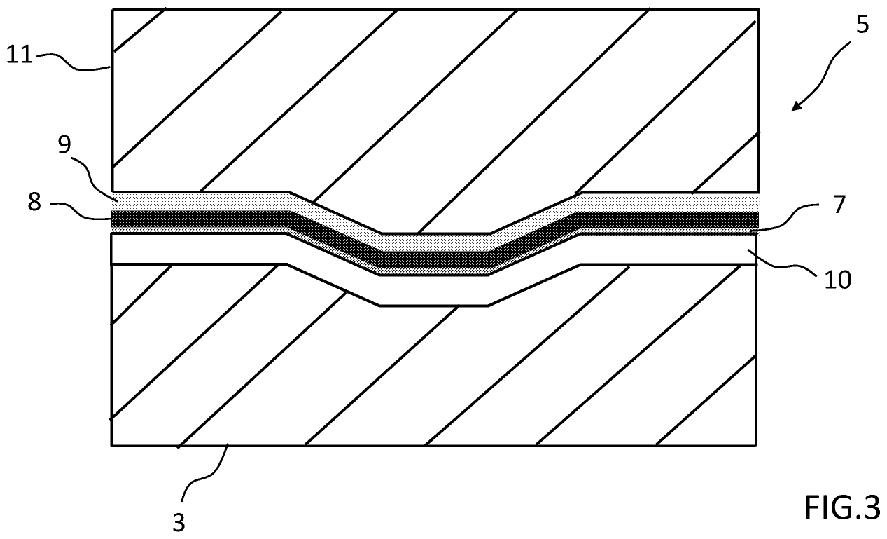

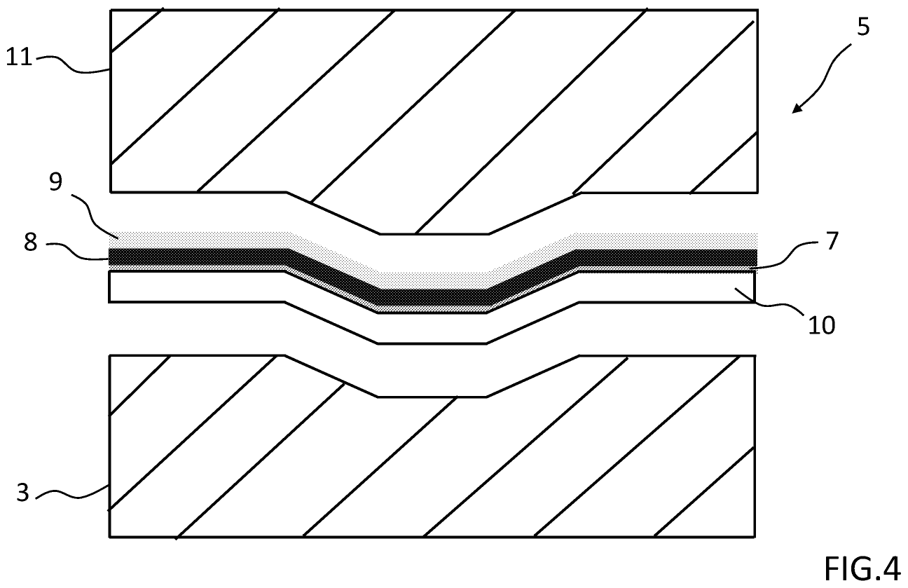

With reference to FIGS. 2-4, in the following it is described an example of a process for coating a preformed substrate 10 that can be implemented by the plant 100 described above.

First of all, it is provided a semi-finished product 99 comprising, superimposed on each other, the above mentioned preformed substrate 10 and a coating layer 6, as well as a layer of adhesive 7 interposed between the preformed substrate 10 and the coating layer 6.

Exemplarily the preformed substrate 10 is in single piece and made of rigid polymeric material, for example polyurethane.

In one alternative embodiment the preformed substrate 10 can be made of metal or wood material. Alternatively, the preformed substrate 10 may be made of a composite material comprising a polymeric matrix (exemplarily in one or more among: polyolefin, polyester, polyamide, polyurethane or mixtures thereof) and fibres incorporated into the matrix, for example: natural textile fibres (e.g., cotton, hemp, jute, linen), synthetic textile fibers (e.g., polymers such as nylon, polyethylene, aramids, polyester), glass fibers, carbon fibers (examples of composite material may be NFPP or GFPP). The process according to the present invention allows to cover substrates with very different mechanical and surface properties.

Exemplarily the preformed substrate 10 has a thickness equal to about 4 mm. Typical values of thickness of the substrate 10 are between 0.5 mm and 8 mm.

Exemplarily the preformed substrate 10 has a three-dimensional shape which is conferred before the process for coating, for example by a moulding process (not shown) of a raw material for forming the substrate 10. The above-mentioned form of substrate 10 exemplarily comprises portions with complex geometry (in the, simplified, shown example it has a recess with two oblique side walls).

Exemplarily the coating layer 6 comprises an aesthetic sheet 9 made of Alcantara™ and in single piece (that is, not including joints, such as seams, welds, glues, and/or solutions of continuity along a surface extension thereof).

Exemplarily the aesthetic sheet 9 has a thickness equal to about 1 mm. Typical values of thickness for the aesthetic sheet 9 are between 0.1 mm and 6 mm.

In other embodiments (not shown) the aesthetic sheet can comprise, or be made of, different materials from those just mentioned (such as natural leather, other types of artificial leather, e.g., Feel Tek™, Ultrasuede™, or even synthetic or natural fabric). In addition, the aesthetic sheet can also be made by means of a plurality of patches sewn together. The patches can for example be made of a single material, or different materials.

Exemplarily the coating layer 6 also comprises a functional layer 8, for example made of open cell (or alternatively closed cell) polyurethane foam, arranged between the substrate 10 and the coating layer 6, preferably directly in contact with the aesthetic sheet 9, to give the finished product a property of softness to the touch (i.e., soft-touch properties).

Exemplarily the functional layer 8 made of polyurethane foam has a thickness equal to about 3 mm (with typical values of thickness comprised between 0.5 mm and 5 mm), and a density equal to about 80 kg/m³ (with typical values of density comprised between 20 kg/m³ and 300 kg/m³).

Alternatively, the functional layer 8 can be made of fabric. For example (not shown), the functional layer may comprise a mesh of fibres/filaments interposed between two sheets (such as the product 3MESH™ marketed by MÜLLER TEXTIL GmbH), or alternatively be a non-woven fabric, such as polyester, and have a weight per unit area (“grammage”) for example equal to about 200 g/m² (with typical grammage values for the functional layer made of non-woven fabric comprised between 40 g/m² and 400 g/m²). These materials lend themselves to provide the desired soft-properties typically required by finished composite products for inner finishes of vehicles.

In one alternative not shown embodiment the coating layer comprises only the aesthetic sheet. In this way hardness to the touch to the finished product (i.e., hard-touch properties) is given. Exemplarily the adhesive is a reactive hot melt polyurethane adhesive. Alternatively, the adhesive can be a reactive water-based adhesive comprising a polyurethane resin. The stable adhesion by the reactive adhesives is achieved by: physical crosslinking caused by temperature variation due to cooling after the infrared heating, and chemical crosslinking due to the formation of chemical bonds between the adhesive components.

Exemplarily the layer of adhesive 7 has a constant grammage (at all phases of the process) and equal to about 80 g/m² (with typical grammage values of the layer of adhesive comprised between 20 g/m² and 160 g/m² ). In this way, it is possible to provide the appropriate adhesive properties by limiting the amount of adhesive used.

Exemplarily the hot melt adhesive is applied at only one between the substrate 10 and the coating layer 6 (thus simplifying and/or speeding up the realization of the semi-finished product), by a manual operation or by automated machinery (not shown).

In case of water-based adhesive, the adhesive can be sprayed or coated to both the substrate 10 and the coating layer 6.

Furthermore, the adhesive can be applied only at certain portions of the substrate and/or of the coating layer respectively, and/or following a pattern, such as lines or dots. Alternatively, the adhesive can be applied along a whole surface extension of the substrate and/or the coating layer respectively. The adhesive can also be applied in uniform way or by providing zones with larger amount of adhesive (for example wherein stronger bonding is required).

Once provided the semi-finished product 99, the process exemplarily comprises placing the semi-finished product 99 on the support surface 4 of the support element 3 (corresponding to the support surface 14 and to the second half-mould 12 respectively) with the preformed substrate 10 proximal to support element 3 (i.e. with the first face 15 in direct contact with the support surface 4-FIG. 2). The support surface 4 (counter-shaped to the first face 15) receives the semi-finished product 99 contacting the substrate 10 at each point (i.e. without leaving empty portions below the substrate).

At this point, it is provided heating by infrared irradiation (FIG. 2) the semi-finished product 99 for bringing the layer of adhesive 7 to a temperature greater than an activation temperature of the adhesive (for example, greater by about 5/10 °C but not exceeding 20 °C above such activation temperature). For example, a hot melt polyurethane adhesive having the activation temperature between about 60-65 °C, is brought to a temperature around 70 °C. The activation temperature is specific of the particular material or mixture of materials of which the adhesive is composed.

Exemplarily, before heating the semi-finished product by infrared irradiation, it is possible fixing the position of the coating layer on the preformed substrate, for example by means of mechanical fixing means, e.g., pre-fixing blades, mechanical clamps as of the type marketed by Destaco GmbH, or by localized manual pre-activation (heating) of some portions of adhesive.

During the infrared heating (and also in the following steps), the support element 3 is advantageously maintained (e.g., thermoset by the above-mentioned first thermo-conditioning device) at a temperature equal to about 45-50 °C. Alternatively, it is also possible to maintain the support element 3 at above-mentioned temperature only during the heating by infrared irradiation.

Exemplarily a first distance H1, along a reference direction 401 (for example vertical), between each irradiation point of each of the infrared sub-sources 2 and the free face 21 of the coating layer 6 is comprised in a symmetrical neighborhood (e.g. +/−15%) of a first reference value.

Preferably a second distance H2, along the reference direction 401, between each point of the fixing surface 20 and the free face 21 of the coating layer is comprised in a second symmetrical neighborhood (e.g. +/−10%) of a second reference value.

For example, in the case of double filament lamps (as described above in relation to the example of FIG. 1-2), the first (or the second) reference value is equal to 1.5 times the pitch between adjacent lamps (in the example for a pitch equal to 100 mm, the first value is equal to 150 mm). In the case of single filament lamps (not shown), the first reference value may be chosen equal to 1.7 times the above-mentioned pitch.

In other words, with reference to the example of FIG. 2, at the whole superficial extension of the free face 21, assuming a first reference value equal to about 150 mm and a first symmetrical neighborhood with extremes respectively equal to about +/−10% of the first reference value, the distance between the infrared source 1 and free face 21 is comprised in the range with extremes 135 mm and 165 mm. This uniformity of distance is obtained by appropriate arrangement in the space of the sub-sources.

In the case of lamellar source (FIG. 5), it is possible to predetermine the value of the first reference value, for example a value equal to about 55 mm. Exemplarily the first neighborhood is equal to +/−15% of this value, namely about 47-63 mm. Exemplarily the second reference value is equal to 60 mm and the first neighborhood is equal to 54-66 mm (+/−10%).

The heating by infrared irradiation has a duration equal to for example of approximately 30 seconds (and for example less than 120 seconds). In this way, the heating is effectively realized while maintaining limited the overall time frame of the process.

At the end of the heating, the support element 3 is moved (shifted) from the first to the second position (as explained above) in order to be located below the first half-mould 11, with the compression surface 13 of the first half-mould 11 and the support surface 4 facing each other (FIG. 1).

The process at this point exemplarily comprises compressing the semi-finished product 99 by pressing the first half-mould 11 and the support element 3 against each other (e.g., by vertical downward movement of the first half-mould 11) with the semi-finished product 99 interposed between the compression surface 13 and the support surface 4.

Advantageously, the above compression step is performed immediately after the above-mentioned heating phase by infrared irradiation, without further intermediate treatment steps. For example, between the end of the heating and the beginning of the compression step can take at most about 15-30 seconds.

During the compression, the first half-mould 11 (e.g., at least the body making its compression surface 13) is exemplarily maintained (e.g., thermoset, by the aforementioned second thermo-conditioning device) at a temperature lower than the activation temperature of the adhesive, with this temperature of the first half-mould 11 exemplarily equal to about 20 °C. In this way, it is promoted the fast cooling of the semi-finished product during the compression, in order to cool the adhesive and consolidate the adhesion between substrate and coating layer.

Exemplarily, during the compression, the first half-mould 11 and the support element 3 exert a pressure on the semi-finished product 99 equal for example to about 0.8 bar (in order to promote the adhesion without damaging the substrate shape).

Once the compression step is finished (which exemplarily has a duration of about 30 seconds, and however typically less than 60 seconds), it is provided removing the first half-mould 11 from the support element 3 (moving upwards the first half-mould 11 along the closing direction 400) so that the finished composite product can be extracted. Subsequently, the support element 3 is returned to the first position, i.e., below the infrared source 1, to begin the process for coating a further substrate.

1. A process for coating a preformed substrate, wherein the process comprises:
providing a semi-finished product comprising:
i) said preformed substrate,
ii) a coating layer superimposed to said preformed substrate, and
iii) a layer of adhesive interposed between said preformed substrate and said coating layer;
heating said semi-finished product by infrared irradiation for bringing said layer of adhesive to a temperature greater than or equal to an activation temperature of said adhesive; and
subsequently, compressing said semi-finished product by pressing said preformed substrate and said coating layer against each other, while cooling said coating layer.

2. The process according to claim 1, wherein heating said semi-finished product by infrared irradiation is performed with said semi-finished product laid on a support surface of a support element, wherein the process comprises arranging said semi-finished product in a mould comprising a first and a second half-mould each having a respective compression surface counter-shaped to said preformed substrate, wherein a time interval between an end instant of said heating and a start instant of said compressing is less than or equal to 60 seconds, wherein said compressing said semi-finished product is performed by pressing said first and second half-mould against each other, with said semi-finished product interposed between said compression surfaces and with said coating layer proximal to said first half-mould, wherein, during said compressing, a pressure exerted by said first and second half-moulds on said semi-finished product is less than or equal to 1.5 bar and greater than or equal to 0.2 bar, and wherein said cooling is performed while keeping a temperature of said first half-mould less than or equal to 30 °C.

3. The process according to claim 2, wherein said support element coincides with said second half-mould and said support surface coincides with said compression surface of the second half-mould, wherein providing said semi-finished product comprises laying said semi-finished product on the compression surface of the second half-mould in a separate position from the first half-mould, wherein the process comprises moving the semi-finished product by translation of the second half-mould from a first position, in which faces an infrared source, to a second position, in which is located at the first half-mould, and vice versa, wherein said compression surface of the second half-mould is substantially counter-shaped to a first face of said preformed substrate facing towards said second half-mould, and wherein, during said heating the semi-finished product, the process comprises keeping said second half-mould at a temperature greater than or equal to 35 °C and less than or equal to 65 °C.

4. The process according to claim 1, wherein heating said semi-finished product by infrared irradiation is performed by directly irradiating a free face of said coating layer and maintaining, along a reference direction, a first distance between each irradiating point and said free face of the coating layer within a first neighbourhood of a first reference value having extremes respectively equal to +/−15% of said first reference value.

5. The process according to claim 1, wherein heating said semi-finished product by infrared irradiation is performed in a time interval greater than or equal to 5 s and by an infrared source comprising a main body having a fixing surface, facing said substrate, counter-shaped to said second face of the substrate, and a plurality of sub-sources fixed to said main body at said fixing surface and spatially homogeneously distributed on said fixing surface, and wherein a second distance, along a reference direction, between each point of said fixing surface and a free face of said coating layer is comprised within a second neighbourhood of a second reference value having extremes respectively equal to +/−15% of said second reference value.

6. The process according to claim 4, wherein each sub-source is a filament infrared lamp, wherein a pitch between two adjacent filament infrared lamps is greater than or equal to 70 mm and less than or equal to 140 mm, wherein said first or second reference value is calculated as a product of a predetermined coefficient, greater than or equal to 1.3 and less than or equal to 2, and said pitch.

7. The process according to claim 4, wherein said main body is made of a thermally and/or electrically insulating material, wherein each sub-source is a metal strip suitable for emitting infrared radiation when brought to a determined temperature, wherein each strip is deformable, is made of Ni—Cr alloy, is in single piece, has a wavy development along a main development line, has a width greater than or equal to 2 mm and less than or equal to 40 mm and a thickness greater than or equal to 0.01 mm and less than or equal to 3 mm, wherein said main body comprises a layer of electrically insulating material defining said fixing surface, and wherein said first or second reference value is greater than or equal to 15 mm and less than or equal to 150 mm.

8. The process according to claim 1, wherein said activation temperature of the adhesive is greater than or equal to 45 °C and less than or equal to 95 °C, and wherein said temperature of the layer of adhesive at the end of said heating by infrared irradiation exceeds said activation temperature of the adhesive by a value less than or equal to 25 °C.

9. The process according to claim 1, wherein said adhesive is a reactive hot-melt adhesive or a reactive water-based adhesive, wherein said adhesive comprises a first component selected from: acrylic resin, polyurethane resin, epoxy resin, silicone resin, neoprene resin, polyolefin resin, polyamide resin, wherein providing said semi-finished product comprises spraying and/or spreading said adhesive on at least one of said substrate and coating layer, and wherein said layer of adhesive has a weight per unit area greater than or equal to 20 g/m² and less than or equal to 160 g/m².

10. The process according to claim 1, wherein said preformed substrate is made of one between: polyurethane, polyvinylchloride, polystyrene, natural fiber, polyethylene terephthalate, polypropylene, or combinations thereof, wherein said coating layer comprises an aesthetic sheet which realizes a free face of the coating layer and it is made of one or more between: natural leather, imitation leather, polyurethane, polyvinylchloride, thermoplastic olefins, fabric made of synthetic or natural textile fibers, wherein said aesthetic sheet is in single piece or comprises a plurality of pieces sewn together, wherein, before said heating by infrared irradiation, the process comprises fixing a position of said coating layer on said preformed substrate by fixing means or by localized pre-activation of some portions of adhesive, and wherein said coating layer comprises a functional layer made of open-cells or closed-cells polymeric foam coupled with said aesthetic sheet and interposed between said layer of adhesive and said aesthetic sheet.
